(19) United States
(12) Patent Application Publication
(10) Pub. No.: US 2015/0254695 A1
(43) Pub. Date: Sep. 10, 2015

(54) COMPUTER IMPLEMENTED METHOD AND SYSTEM FOR REWARDING USER FOR INTERACTING WITH GAMING AND ADVERTISING MEDIA

(71) Applicants: Marcus Germaine Howard, Tampa, FL (US); Malcolm Garrard Howard, Statesboro, GA (US)

(72) Inventors: Marcus Germaine Howard, Tampa, FL (US); Malcolm Garrard Howard, Statesboro, GA (US)

(21) Appl. No.: 14/642,572

(22) Filed: Mar. 9, 2015

Related U.S. Application Data
(60) Provisional application No. 61/949,602, filed on Mar. 7, 2014.
(60) Provisional application No. 61/989,201, filed on May 6, 2014.

(51) Int. Cl. G06Q 30/02

(52) U.S. Cl. CPC G06Q 30/0209; G06Q 30/0269

(57) ABSTRACT

The present invention discloses a computer implemented method for rewarding a user for interacting with gaming media, the computer implemented method which comprises retrieving a gaming media from a database comprising plurality of gaming media, playing the gaming media to the user, the gaming media being played by a media player, calculating bits corresponding to the played gaming media, the bits being calculated based on a predefined algorithm, computing tokens when number of calculated bits become more than a threshold value and storing the calculated bits and tokens to the corresponding user profile. The user is able to utilize the rewarded tokens for transactions on the World Wide Web.

### FIELD OF THE INVENTION

The present disclosure relates to the field of gaming and multimedia. In particular, the present invention provides a computer implemented method for rewarding a user for interacting with gaming/advertising media, like watching and sharing videos from different devices across the World Wide Web.

### BACKGROUND OF THE INVENTION

In today's world watching and sharing of media online has become very common. Easy and fast access of the internet has made things simpler and more interactive to a user. However, when we come across gaming consoles, we find that gaming devices do not include easily accessible and flexible services to view media like audio, video, static images, etc. from games.

Usually, gaming media is directly derived from or related to a game or its intellectual property like characters, levels, music, etc. So, even if a user beats a game in one console, there's no way to view the content from that game on another console. Gaming consoles are not portable, so it's difficult to view gaming media on the go. Also, since these console platforms aren't integrated, it's impossible to view gaming media from multiple console providers.

Moreover, gaming devices do not have the feature for easy access to listen to the audio, view the video or the static images etc. from games. Therefore, there is a constant need for a method and system, which enables a user to access or view the gaming videos from other gaming consoles as well. There is a further need for providing a method, which provides an integration of gaming consoles from various platforms on a single platform. Moreover, there is also a need to provide a system which creates a digital reference tool for the gaming industry so that gamers may use this reliable resource as a visual encyclopedia to discover, watch and share old and new games.

### SUMMARY OF THE INVENTION

In view of the aforesaid needs and shortcomings in the state of the art, in an aspect, the present invention provides a computer-implemented method for rewarding a user for interacting with gaming media. The computer-implemented method includes retrieving a gaming media from a database. The database includes plurality of gaming media stored therein. The retrieved gaming media is thereafter played to the user using a media player. The computer-implemented method further includes calculating the bits corresponding to the played gaming media based on a predefined algorithm, while the media is being played. The method further includes computing tokens when number of calculated bits become more than a threshold value. The method further includes storing the calculated bits and tokens to the corresponding user profile.

In one embodiment of the present invention, the user is able to utilize the rewarded tokens for transactions on the World Wide Web.

In another embodiment of the present invention, the user is able to exchange the tokens for buying shares of companies.

In another embodiment of the present invention, the user is able to exchange the tokens to purchase and play games on the world wide web.

In yet another embodiment of the present invention, the user is able to exchange the tokens to purchase merchandize on the world wide web.

In yet another embodiment of the present invention, the user is able to utilize the rewarded tokens for playing locked gaming media in the database.

In one embodiment of the present invention, the gaming media is at least one of video files, static images, audio files, Audio/Video files, and the like, accumulated from various gaming consoles.

These aspects together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there is illustrated an exemplary embodiment of the present invention.

### BRIEF DESCRIPTION OF THE DRAWINGS

The advantages and features of the present invention will become better understood with reference to the following detailed description taken in conjunction with the accompanying drawings, in which:

FIG. 1 illustrates various elements involved in the application as disclosed in the present invention, according to various embodiments of the present invention;

FIG. 1(a) illustrates various layers of the application, according to various embodiments of the present invention;

FIG. 2 illustrates a flowchart depicting how the application calculates reward points for a user, according to various embodiments of the present invention;

FIG. 3 illustrates a flowchart for inviting friends in the application, according to various embodiments of the present invention;

FIG. 4 illustrates a flowchart of the method for displaying, watching videos in the disclosed method by a user, awarding of bits to a user, user registration, according to various embodiments of the present invention;

FIG. 5 illustrates a flowchart for entering details regarding registration of a user, selecting favorite consoles, genres, games, videos and playing the videos, according to various embodiments of the present invention; and

Like reference numerals refer to like parts throughout the description of the drawings.

### DESCRIPTION OF THE INVENTION

The exemplary embodiments described herein detail for illustrative purposes are subject to many variations in structure and design. It should be emphasized, however, that the present invention is not limited to a particular computer implemented method for rewarding users for interacting with media, like watching, sharing videos from different gaming consoles across the World Wide Web as described. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

The present invention relates to a computer implemented method for rewarding users for interacting with media, like watching, sharing gaming media, stored in database, across the World Wide Web. The term gaming media refers to at least one of video files, static images, audio files, Audio/Video files, and the like, accumulated from various gaming consoles, and stored in the database. The present invention provides ways and means to access such gaming media, presenting the media to users in interactive manner, and rewarding them for viewing the media and sharing it on the world wide web.

The present invention includes a gaming platform for viewing or downloading media with an objective-based reward system of collectable and tradeable, variable-rarity currency. Currency is rewarded for completion of various recurring and non-recurring objectives, including, but not limited to, viewing or interacting with advertising and user content. The platform may include arcade, media, commerce, and social components that exist as subsystems of the gaming platform. Currency can be used in a marketplace for purchases of in-game upgrades and resources, as well as for goods and services that exist inside/outside of the platform. The gaming platform delivers a variety of static/interactive advertising media to the users, and the platform allows for multiple users to simultaneously interact with the advertising media

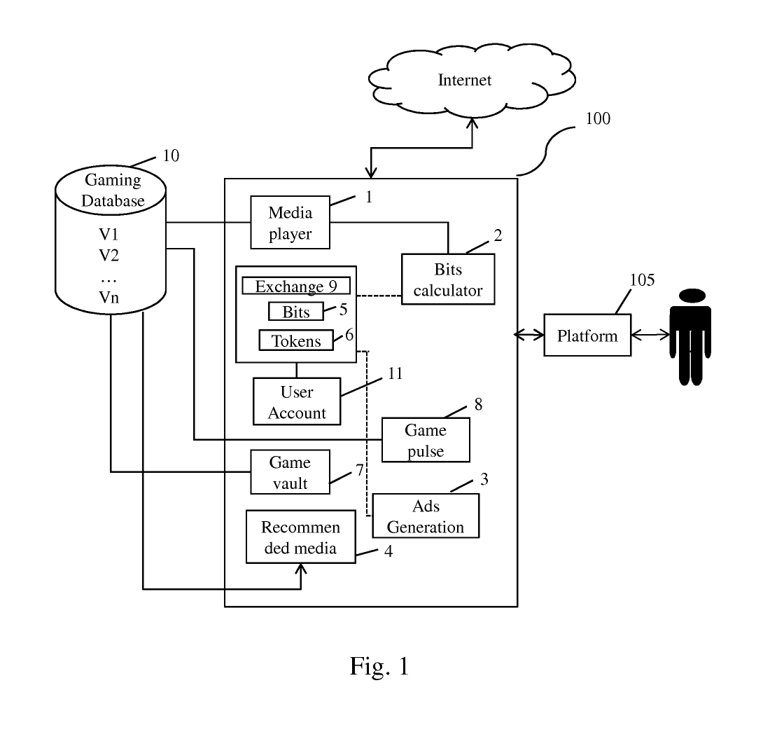

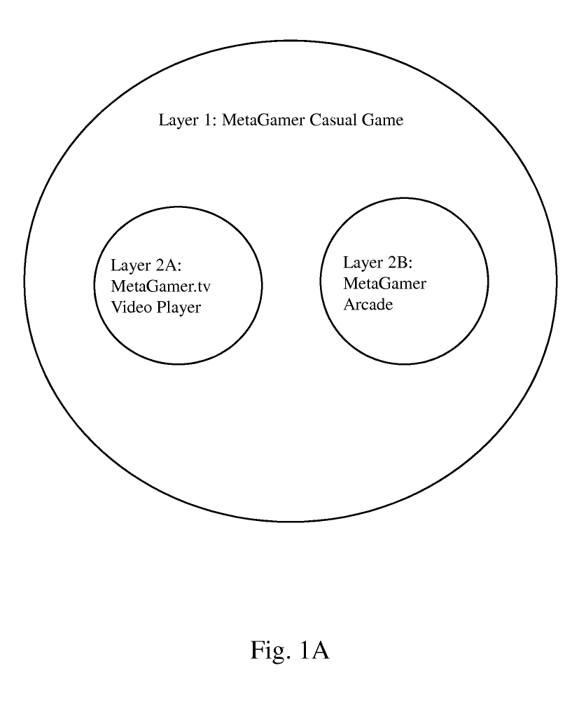

The present invention allows a user to access the said gaming media via a computer, a web browser, a mobile device (tablet or smartphone), smartTV, wearable technology, or virtual reality system but not limited to these computational devices. The present invention provides a software application 100, which will be described herein for allowing such interactive access of the media. The application 100 with the computer implemented method embodied therein is explained below in conjunction with FIGS. 1-6.

With reference to FIG. 1, the various components of the application 100 are described. These components are as follows:

1. High Definition Streaming Media Player

2. Post-Video Bit Calculator

3. Gamified Social Ads

4. Recommended Gaming Media

5. Bits

6. Tokens

7. Game Vault

8. Game Pulse

9. Bit/Token/Share Exchange

10. Gaming media database

11. User Account

The functioning of the application 100 along with functionalities of various components will now be described. At initiation of the application 100, a user signs into and sees a recommended media 4 which includes one or more recommended gaming media for the user.

In one embodiment, the recommended media 4 is retrieved from a database 10, which has various gaming media accumulated from various gaming consoles, and pre-stored therein.

In one embodiment, the recommended gaming media is shortlisted from the database 10 based on the user profile. More specifically, the user profile may also be pre-stored in the database with various profile biographic and other parameters. The computer-implemented method that is embodied in the application 100 may retrieve the gaming media based on these user parameters. For example, if the user is a gamer with high level of gaming experience and competence, the computer implemented method is most likely to retrieve the gaming media (say gaming videos) stored which are categorized in expert category.

After interacting with recommended gaming media 4, the computer-implemented method allows the user to view the gaming media content through the media player 1.

In one embodiment, while the user is watching/viewing the gaming media via the media player 1, the gamified social ads 3 of the application 100 generates interactive ads for the user. In one embodiment, the gamified social ads 3 may incorporate other users using the application 100 for a shared ad experience. This gives an interactive multiple user feel to the application 100.

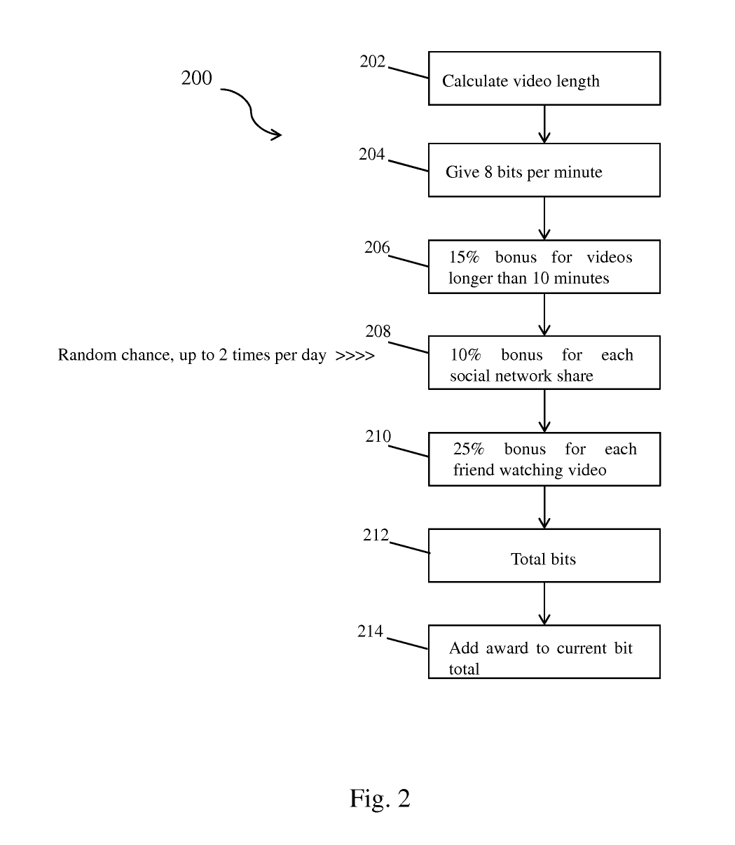

Once viewing of the media is completed by the user, the bit calculator 2 calculates bits earned for watching the media in media player, along with any applicable bit bonuses. In one embodiment, the bits are calculated based on a predefined algorithm. One such algorithm is explained with reference to FIG. 2.

When the calculations from bit calculator 2 are complete, the application 100 displays a total of bits 5 accumulated while watching the video to the user. These bits are thereafter automatically saved to the user's account 11.

In one embodiment, the computer implemented method embodied in the application 100 further computes bonus bits corresponding to the played media, as explained with reference to FIG. 2.

In one embodiment, the computer implemented method computes the bonus bits based on length of the played media.

In another embodiment, the computer implemented method computes the bits based on number of times the played media is shared by the user on social media networks.

In another embodiment, the computer implemented method computes the bits based on number of times friends of the user play the gaming media.

In one embodiment of the present invention, the application 100 computes the number of tokens 6 associated with the bits as computed by the bit calculator 2. More specifically, the application 100 credits a specific amount of tokens after a specific threshold for bits is passed to the user's account 11.

The recommended gaming media 1 is further adapted to suggest new media for the user to select. In one embodiment, the application 100 has some of the gaming media unavailable, and located inside of Game Vault 7. Users can choose to unlock content from Game Vault 7, by spending some of tokens 6 obtained as mentioned above.

The application 100 also includes the Game Pulse 8, which tracks the number of times a particular gaming media is being played. In other words, the Game Pulse 8 represents the popularity of a media on the application 100. As multiple users simultaneously watch/view media through media player 1, the Game Pulse 8 will increase and decrease to reflect the real-time popularity of a video. The Game Pulse 8 influences a bonus number of bits that that are totaled by the Bit calculator 2. The computation of bonus bits is explained later with reference to FIG. 2.

In one embodiment, the application 100 also includes a Bits exchange 9 which operates like a stock market, allowing users to exchange bits for tokens, and tokens for a finite number of available shares of the company.

The tokens as provided to the user may be used for various purposes. The user is able to exchange the tokens to purchase and play games on the world wide web. Further, the user is able to exchange the tokens to purchase merchandize on the world wide web.

The user interacts with the application using a platform 105. In various embodiments, the platform 105 may be any computational device, which can be used to access the application 100. It may include computer, a web browser, a mobile device (tablet or smartphone), smartTV, wearable technology, or virtual reality system but are not limited to these.

Referring now to FIG. 1(a), there is provided a specific implementation of the application 100. The FIG. 1(a) shows integration of three specific ecosystems such as, virtual game world, TV/video platform and arcade. The present invention is capable of accessing games online. The arcade contains numerous web-based video games including web gambling, such as slots and digital scratch off tickets.

Now referring to FIG. 2, there is shown a flowchart explaining the algorithm for calculating the bonus bits for the user. In one embodiment, the bits/bonus bits are calculated based on the length of the video. For instance, 8 bits are credited to the user account for one minute of video. Similarly, 15% bonus bits are rewarded to the user for videos which are longer than 10 minutes.

In another embodiment, 10% bonus bits are rewarded to the user for sharing a video on social media network e.g. facebook etc.

In yet another embodiment, if a friend of the user watches/views a video of the user, 25% bonus bits are credited to the user account.

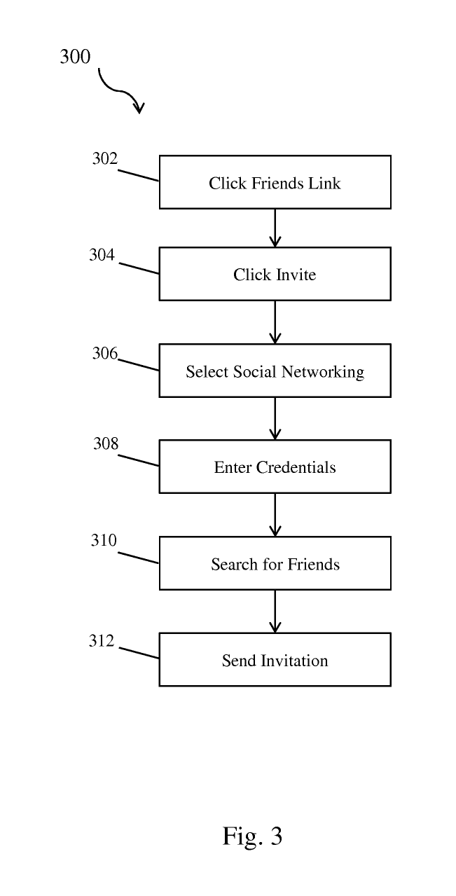

Now referring to FIG. 3, there is provided a flowchart 300 for inviting a friend in the application 100. At step 302, the user clicks on the Friends Link and at step 304, the user clicks on invite. At the next step 306, the user selects Social Networking, and enters credentials at step 308. Then, the method flows to step 310 which searches the friends. Finally at step 312, the user sends the invitation to the friend.

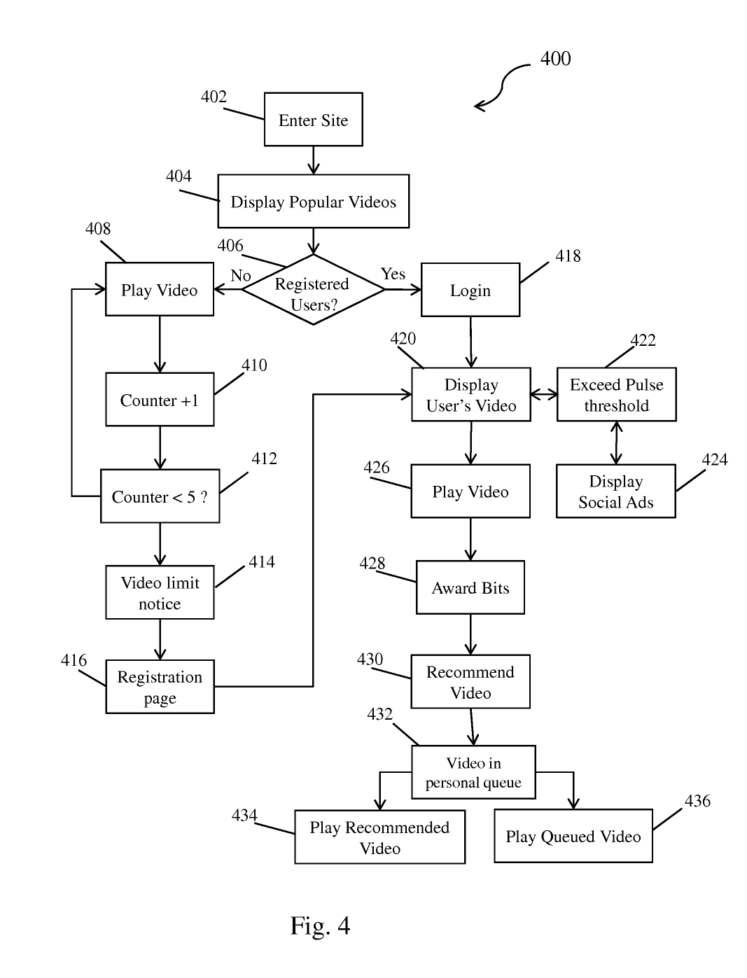

FIG. 4 shows a flowchart 400 describing the interaction of the user with the application 100. At step 402, the user enters the website/user interface of the application 100. At the next step 404, the application 100 displays popular videos to the user. Next the method moves to step 406, where the application 100 checks whether the user is registered or not. If the user is not a registered user, the application 100 moves to step 408 and plays the gaming media or videos to the user. Further, through steps 410 and 412, the application 100 tracks the number of media watched/played by the user.

In case the counter exceeds 5, the application 100 provides Limit notice to the user at step 414 and drives the user to the registration page at step 416. Once the user registers and creates an account, the application 100 takes the user to the display video at step 420.

At step 420, if the application 100 finds that the user is a registered user, the user is navigated to the login page at step 418. While the user is viewing/playing media at step 426, the bit calculator 2 calculates the number of bits based on predefined algorithm as explained in FIG. 3 and awards the calculated bits to the user at step 430.

Further, in steps 432-436, the user may customize and play videos from the recommended media list. The duration, in which the user plays a media, social advertisements are popped up for the user to have shared ad experience at step 424. Further, once the number of bits exceeds a certain threshold, certain amount of token is credited to the user account as in step 422.

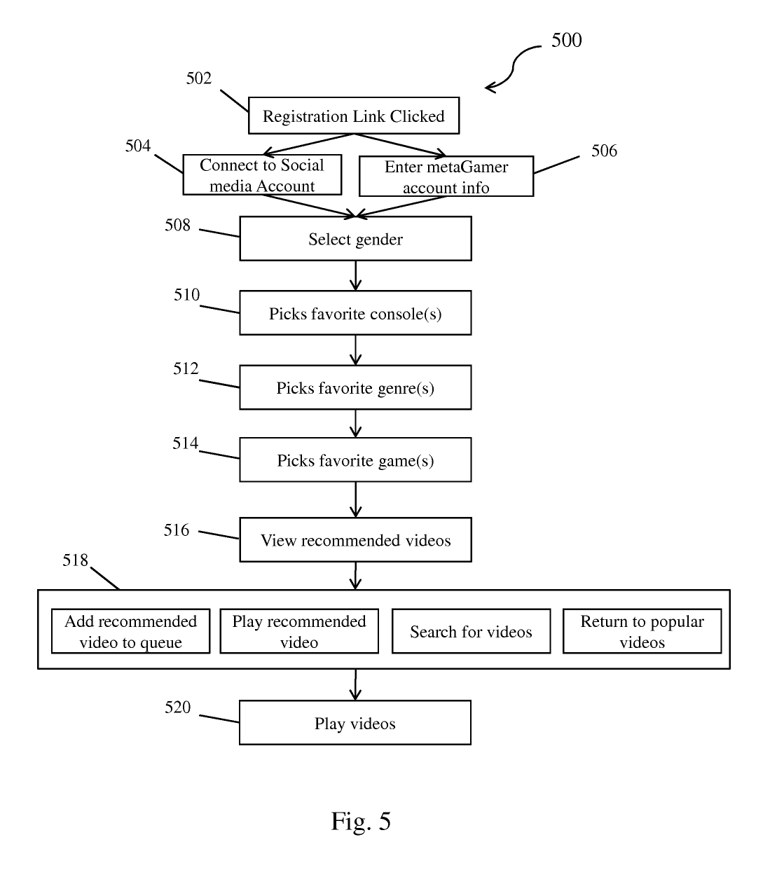

FIG. 5 explains the registration method 500 for the registration of a user into the application 100. The user clicks on the Registration link at step 502. There are two types of accounts, one through social media account like Facebook™, Twitter™ etc. as in 504 and second through entering personal account information as in 506, respectively. At step 508, the user selects the gender. Next, the user selects favorite console at step 510 and favorite genre at step 512. At 514, the user selects favorite game. At step 516, the user views recommended media. At step 518, the user, may perform any of the steps of adding a recommended video to the queue, or playing a recommended video, searching a video, or even return to the popular video list. At step 520, the user enjoys playing the videos.

The present application is built using HTML5, JavaScript, CSS3, and Python. The application is also capable of making API calls to CDN's like YouTube™. To solve the problem of access to gaming videos on multiple console platforms, a user may register for an account with a provider, identify their gaming interests, and begin watching videos. The application will begin suggesting new content to the user, which may be specific to their interests. The preset invention produces tokens, which can be exchanged for shares of corporate stock.

The method and system described above has numerous advantages. The disclosed teachings provide features for easily access to listen to the audio, view the video or the static images etc. from games. More importantly, the disclosed teachings reward a user for interacting with gaming media. Further, the method and system provides a way for an integration of gaming consoles from various platforms on a single platform. The teachings creates a digital reference tool for the gaming industry so that gamers may use this reliable resource as a visual encyclopedia to discover, watch and share old and new games.

The system, as described in the disclosed teachings or any of its components, may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

In a computer system comprising a general-purpose computer, such may include an input device, and a display unit. Specifically, the computer may comprise a microprocessor, where the microprocessor is connected to a communication bus. The computer may also include a memory—the memory may include Random Access Memory (RAM) and Read Only Memory (ROM). The computer system further comprises a storage device—it can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A computer implemented method for rewarding a user for interacting with gaming media, the computer implemented method comprising:
retrieving a gaming media from a database comprising plurality of gaming media;
playing the gaming media to the user, the gaming media being played by a media player;
calculating bits corresponding to the played gaming media, the bits being calculated based on a predefined algorithm;
computing tokens when a number of calculated bits become more than a threshold value; and
storing the calculated bits and tokens to the corresponding user profile,
wherein the user is able to utilize the rewarded tokens for transactions on the world wide web.

2. The computer implemented method as claimed in claim 1, wherein the gaming media is at least one of video files, static images, audio files, and Audio/Video files, accumulated from various gaming consoles.

3. The computer implemented method as claimed in claim 1, wherein the gaming media is retrieved from the database based on the user profile.

4. The computer implemented method as claimed in claim 1, further comprising tracking number of times a particular gaming media is played.

5. The computer implemented method as claimed in claim 1 further comprising,
generating advertisements, and
displaying the advertisements to the user.

6. The computer implemented method as claimed in claim 5, wherein the advertisements are generated based on the user profile.

7. The computer implemented method as claimed in claim 6, wherein the advertisement is generated based on popularity of the played gaming media.

8. The computer implemented method as claimed in claim 1, wherein the user is able to utilize the rewarded tokens for playing locked gaming media in the database.

9. The computer implemented method as claimed in claim 1, wherein the bits are calculated based on length of the played gaming media.

10. The computer implemented method as claimed in claim 1, further comprising computing bonus bits corresponding to the played media.

11. The computer implemented method as claimed in claim 10, wherein the bonus bits are computed based on length of the played media.

12. The computer implemented method as claimed in claim 10, wherein the bonus bits are computed based on number of times the played media is shared by the user on social media networks.

13. The computer implemented method as claimed in claim 10, wherein the bonus bits are computed based on number of times friends of the user play the gaming media.

14. The computer implemented method as claimed in claim 1, wherein the user is prompted to exchange the tokens for buying shares of companies.

15. The computer implemented method as claimed in claim 1, wherein the user is prompted to exchange the tokens to purchase and play games on the world wide web.

16. The computer implemented method as claimed in claim 1, wherein the user is prompted to exchange the tokens to purchase merchandize on the world wide web.
